(19) United States
(12) Patent Application Publication
(10) Pub. No.: US 2023/0064104 A1
(43) Pub. Date: Mar. 2, 2023

(54) SYSTEM AND METHOD FOR AUTONOMOUS AIR-TO-AIR REFUELING OF AN AIRCRAFT

(71) Applicant: Airbus Defence and Space SAU, GETAFE (ES)

(72) Inventor: Alfonso TEJELO MANZANO, GETAFE (ES)

(21) Appl. No.: 17/879,258

(22) Filed: Aug. 2, 2022

(30) Foreign Application Priority Data
Sep. 1, 2021 (EP) 21382790.0

(51) Int. Cl. B64D 39/06; B64D 47/08; B64D 47/02; G05D 1/00; G05D 1/10; G06T 7/73; G06T 7/50; G06V 10/74

(52) U.S. Cl. CPC B64D 39/06; B64D 47/08; B64D 47/02; G05D 1/0094; G05D 1/101; G06T 7/73; G06T 7/50; G06V 10/74; G06T 2207/10032

(57) ABSTRACT

A system and method for autonomous air-to-air refueling of an aircraft arranged on the receiver aircraft, including a vision system for capturing images of the receiver aircraft including the fuel receiving equipment and of the tanker aircraft comprising the dispensing equipment, an image processing system for receiving and processing the images to identify the shape of the fuel receiving equipment, the fuel dispensing equipment and the contour of the tanker aircraft and for calculating a distance between the fuel dispensing equipment and the fuel receiving equipment and the relative attitude of the tanker aircraft, a receiver aircraft positioning system for varying, based on the distance between the fuel receiving equipment and the fuel dispensing equipment and the relative attitude of the tanker aircraft, flight parameters of the receiver aircraft.

### CROSS-REFERENCES TO RELATED APPLICATIONS

This application claims the benefit of the European patent application No. 21382790.0 filed on Sep. 1, 2021, the entire disclosures of which are incorporated herein by way of reference.

### FIELD OF THE INVENTION

The present invention relates to a system and a method for air-to-air refueling of an aircraft during the different stages of air-to-air refueling operation.

### BACKGROUND OF THE INVENTION

Air-to-air refueling systems perform the transfer of fuel from a tanker aircraft to a receiver aircraft coupling dispensing means located in the tanker aircraft and receiving means located in the receiver aircraft.

It is known a dispensing and receiving means known as flying boom comprising a hose passing through a rigid telescopic pipe, the boom. The boom is fixed to a rear portion of the fuselage of the tanker aircraft. The boom is inserted into a receptacle in the receiver aircraft.

A different refueling method comprising different dispensing and receiving means known as hose-and-drogue comprises a flexible hose that trails from the tanker aircraft having a terminal portion called a drogue configured for contacting a probe on the receiver aircraft. The drogue stabilizes the hose in flight and provides a funnel to aid insertion of the receiver aircraft probe into the hose. A probe, which is a rigid, protruding or pivoted retractable arm placed on the aircraft's nose or fuselage to make the connection.

In both cases, the receiver aircraft must first carry out a correct approach to the tanker aircraft, keeping an appropriate distance and then maintaining its position and speed with respect to the tanker aircraft.

The operation of approach of the receiver aircraft to the area for refueling, known as rendezvous area or precontact area, is executed by the pilot of the receiver aircraft.

Afterwards, the fine approach for contact and engagement from astern between the dispensing means located in the tanker aircraft and the receiving means located in the receiver aircraft has to be performed. An active intervention of the pilot of the receiver aircraft is needed in the pre contact and contact phase and during dispensing phase in maintaining the position of the receiver aircraft stable with respect to that of the tanker aircraft in addition to control and monitoring the proper function of fuel system once in contact.

Air-to-Air refueling field is interested in refueling an aircraft without a human at the controls, either on tanker and/or receiver aircraft.

Known solutions to Automated Air-to-Air refueling are focused on the relative positioning of the tanker aircraft versus the receiver aircraft. For that purpose, the tanker aircraft and the receiver aircraft need to fit specific equipment that permits a stable control of receiver aircraft positioning during the critical phases of inflight refueling, i.e., precontact, contact, fuel dispensing and disconnection. For instance, camera image processing computers, probe versus drogue position sensors, standardized command and control messages from tanker aircraft to receiver aircraft, etc.

In case a fully autonomous control of the whole refueling operation is desired with current solutions, both tanker aircraft and receiver aircraft shall install dedicated equipment to permit the transmission of necessary parameters related to tanker dispense equipment availability, relative position between both tanker and receiver and permission to start/stop the operation. This will limit automated refueling operations to certain couples of tanker aircraft versus receiver aircraft that will both need to fit the required equipment.

### SUMMARY OF THE INVENTION

It is an object of the present invention a system and a method for autonomous air-to-air refueling of an aircraft during the different stages of air-to-air refueling operation.

The claimed system is configured for being fully arranged on a receiver aircraft configured to be refueled by a tanker aircraft.

As previously stated, the receiver aircraft comprises a fuel receiving equipment and the tanker aircraft comprises a fuel dispensing equipment. The fuel receiving equipment is configured for receiving fuel from the fuel dispensing equipment.

The system for autonomous air-to-air refueling of an aircraft during the different stages of air-to-air refueling operation comprises:

A vision system configured for being arranged on the receiver aircraft and configured for capturing images of at least a portion of the receiver aircraft comprising the fuel receiving equipment and at least a portion of the tanker aircraft comprising the dispensing equipment. Therefore, the vision system is able to capture images of the receiving equipment, the dispensing equipment and at least a portion of the receiver and the tanker aircraft.

An image processing system arranged on the receiver aircraft and configured for receiving the images captured by the vision system. The image processing system is configured for processing the captured images to identify the shape of the fuel receiving equipment and of the fuel dispensing equipment and at least the contour of a portion of the tanker aircraft. The image processing system is also configured to calculate the distance, in an appropriate coordinates system, for instance, a cartesian coordinate system, between the fuel dispensing equipment and the fuel receiving equipment and the relative attitude of the tanker aircraft with respect to the receiver aircraft.

The image processing system is configured to identify the shape, i.e., the spatial form of the main elements of the equipment. For instance, the external contour of the equipment and the contour and location of the coupling area. For the tanker aircraft, the system is configured to identify at least the contour, i.e., the outline or line that marks the outer limits of the tanker aircraft.

The image processing system is also configured to calculate the relative attitude of the tanker aircraft with respect to the receiver aircraft. The relative attitude is the orientation in space of the tanker aircraft with respect to the receiver aircraft.

Object orientation in aviation uses three angles:

yaw (around the yaw axis)

pitch (around the lateral axis)

roll or bank (around the longitudinal axis).

A receiver aircraft positioning system in communication with the image processing system. The positioning system is configured for varying, based on the distance between the fuel receiving equipment and the fuel dispensing equipment and the relative attitude of the tanker aircraft, flight parameters of the receiver aircraft for approaching and aligning the receiver aircraft with the tanker aircraft so that the fuel dispensing equipment and the fuel receiving equipment make contact, maintain contact or disconnect for performing a refueling operation.

Thus, the receiver aircraft approaches, i.e., comes very near to the tanker aircraft and the receiver aircraft corrects its relative position with respect to the tanker aircraft so that the dispensing and receiving equipment are able to make and maintain contact or disconnect.

An object of the invention is to allow the full autonomous control of the air-to-air refueling operation independently from the tanker aircraft by fitting on the receiver aircraft a dedicated control and monitoring system that identifies the tanker attitude and relative distance between the fuel receiving equipment and the fuel dispensing equipment. For instance, it identifies the distance in an appropriate coordinate system between the probe or receptacle versus the tanker dispense equipment drogue or boom mast nozzle.

In addition to receiver aircraft positioning, the system may be capable to autonomously control receiver fuel system by opening and closing the necessary valves to reach desired fuel on board target.

The claimed system performs an interface with the receiver aircraft flight Control, Guidance and Flight Management Systems permitting to send necessary commands to control flight control surfaces, vertical and lateral degrees of freedom, and engine thrust, longitudinal degree of freedom, as required by tanker aircraft versus receiver aircraft position image control loop during each air-to-air refueling phase.

The advantage of identifying the contour of at least a portion of the tanker aircraft and its attitude is that, when contact is performed, it is possible to control if the receiver aircraft is dragging the dispensing means too far up/down or right/left with respect to the tanker aircraft and an undesired disconnection may occur. Also, having the information about tanker's attitude would allow to make contact in a turn which is a normal scenario during refueling operations.

Additionally, the system may be capable of recognizing dispense equipment signal lights or Pilot Director Lights (PDLs), hose refueling marks or boom telescopic beam marks, permitting to enable and to control the contact position between tanker and receiver within a refueling range. The system will be capable to recognize either of the previously mentioned items depending on the receiver aircraft fitting a probe or a receptacle respectively.

The system may also allow to autonomously control the opening/closure of receiver fuel system based on image processing from the vision system installed on the receiver aircraft.

It is also an object of the invention a receiver aircraft that comprises a system for autonomous air-to-air refueling of an aircraft during the different stages of air-to-air refueling operation according to the above mentioned.

Additionally, the main advantages of the invention are listed as follows:

Independency from tanker aircraft. Current autonomous air-to-air refueling solutions rely on a joint data transmission system than needs to install dedicated equipment on both the tanker aircraft and receiver aircraft.

Applicability in drones or unmanned aerial vehicles (UAV) to allow a full autonomous air-to-air refueling operation, without a human on the loop, that will extend the operational range.

To perform air-to-air refueling on silent communications, in day and night conditions.

The claimed system could be integrated on existing aircraft fitting refueling probe or receptacle.

For manned aircraft, it will significantly lower the workload during air-to-air refueling operations increasing the safety margins as crew will only monitor that the air-to-air refueling operation develops as expected.

It is also an object of the invention a method for autonomous air-to-air refueling of an aircraft during the different stages of air-to-air refueling operation comprising the following steps:

capturing images by a vision system arranged on the receiver aircraft of at least a portion of the receiver aircraft comprising the fuel receiving equipment and at least a portion of the tanker aircraft comprising the dispensing equipment, sending the captured images to an image processing system arranged on the receiver aircraft,

processing the received captured images by the image processing system identifying the shape of the fuel receiving equipment and of the fuel dispensing equipment and the contour of at least a portion of the tanker aircraft and calculating the distance between the fuel dispensing equipment and the fuel receiving equipment and the relative attitude of the tanker aircraft with respect to the receiver aircraft,

varying, based on the distance between the fuel receiving equipment and the fuel dispensing equipment and the relative attitude of the tanker aircraft, flight parameters of the receiver aircraft by a receiver aircraft positioning system in communication with the image processing system for approaching and aligning the receiver aircraft with the tanker aircraft so that the fuel dispensing equipment and the fuel receiving equipment make contact, maintain contact or disconnect for performing a refueling operation.

### BRIEF DESCRIPTION OF THE DRAWINGS

To complete the description and to provide for a better understanding of the invention, a set of drawings is provided. Said drawings form an integral part of the description and illustrate preferred embodiments of the invention. The drawings comprise the following figures.

FIG. 1 shows a schematic view of an embodiment of a camera and the identification system in an alignment phase.

FIG. 2 shows a schematic view of an embodiment of a camera and the identification system in a dispensing phase.

FIG. 3 shows a schematic view of an embodiment of visual signals indicating that the receiver aircraft is located in an optimum refueling zone with respect to the tanker aircraft.

FIG. 4 shows a schematic perspective view of an embodiment of a tanker aircraft showing Pilot Director Lights.

### DETAILED DESCRIPTION OF THE PREFERRED EMBODIMENTS

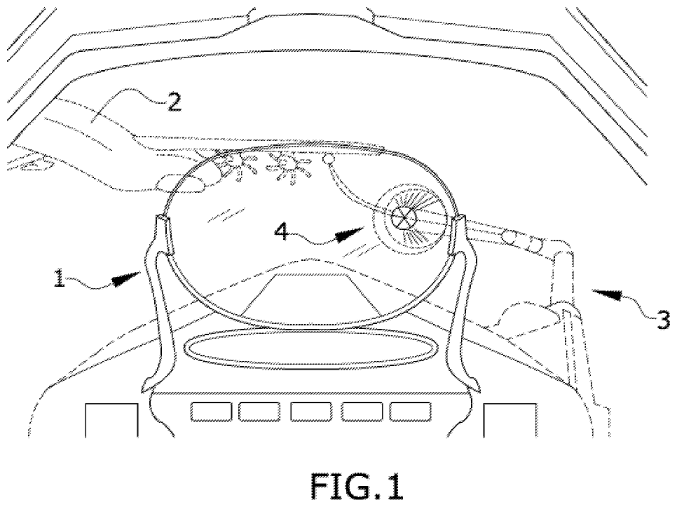

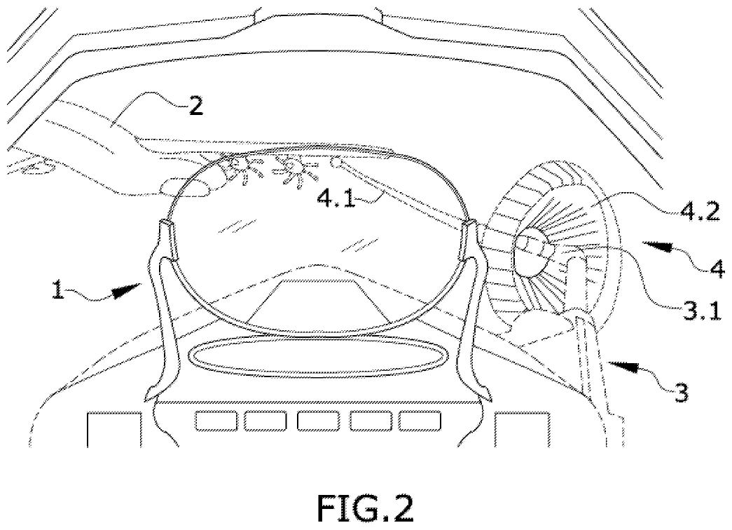

FIGS. 1 and 2 disclose a captured image depicting a portion of the receiver aircraft (1) which is to be refueled by the tanker aircraft (2). The receiver aircraft (1) comprises the fuel receiving equipment (3) and the tanker aircraft (2) comprises the fuel dispensing equipment (4). In the embodiment shown in the figures, the refueling system is a hose-and-drogue system that comprises a flexible hose (4.1) that trails from the tanker aircraft (2) having a drogue (4.2) in a terminal portion of the hose (4.1). The receiving equipment (3) comprises a probe (3.1) located on the receiver aircraft (1).

The vision system captures images of the portion of the receiver aircraft (1) comprising the fuel receiving equipment (3) and of the surroundings of the receiver aircraft (1) comprising at least a portion of the tanker aircraft (2) and the dispensing equipment (4).

The image processing system receives the images captured by the vision system and processes them to identify the shape of the fuel receiving equipment (3) and of the fuel dispensing equipment (4). This is seen in FIGS. 1 and 2 in dotted lines. The image processing system also identifies the contour of a portion of the tanker aircraft (2). Additionally, in the shown embodiment it identifies the contour of a portion of the receiver aircraft (1).

The image processing system calculates the relative distance between the fuel dispensing equipment (4) and the fuel receiving equipment (3). In an embodiment, the relative distance between the fuel dispensing equipment (4) and the fuel receiving equipment (3) is configured to be calculated by the distance in an appropriate coordinate system, for instance, a cartesian coordinate system, between a coupling area of the fuel receiving equipment (3) and a coupling area of the fuel dispensing equipment (4). The coupling area is the area where both elements (3, 4) are coupled together for fuel transfer.

In an embodiment, the image processing system calculates the distance between the center of the drogue (4.2) and the probe (3.1).

The receiver aircraft positioning system varies, based on the distance between the fuel receiving equipment (3) and the fuel dispensing equipment (4) and the attitude of the tanker aircraft (2), flight parameters of the receiver aircraft (1) for approaching and aligning the receiver aircraft (1) to the tanker aircraft (2) so that the fuel dispensing equipment (4) and the fuel receiving equipment (3) make and maintain contact for performing a refueling operation.

The flight parameters of the receiver aircraft (1) may be height, lateral displacement and/or engine thrust.

All the relative position calculations would be converted to the reference system required by the flight control system to control the aircraft's horizontal, vertical and longitudinal degrees of freedom.

In an embodiment, the system for autonomous air-to-air refueling of an aircraft comprises an opening and closing system of the fuel receiving equipment (3) configured for opening the fuel receiving equipment (3) according to a valid preset distance between the fuel receiving equipment (3) and the fuel dispensing equipment (4) and on the relative attitude of the tanker aircraft (2). Said valid preset distance indicates that all the conditions needed to do the contact, such as the receiver aircraft (1) being within the refueling range and the appropriate relative distance between the two elements, have been fulfilled.

Additionally, the opening and closing system of the fuel receiving equipment (3) may comprise a fuel weight measurement system and is configured for closing the fuel receiving equipment (3) at a valid preset fuel weight of the receiver aircraft (1). Controlling the valid preset fuel weight of the receiver aircraft (1) is possible to control the fuel that has been transferred.

In an embodiment, the fuel dispensing equipment (4) comprises visual signals indicating that the receiver aircraft (1) is located in an optimum refueling zone with respect to the tanker aircraft (2). The image processing system is configured for identifying in the captured images the visual signals and the receiver aircraft positioning system is configured to vary the flight parameters of the receiver aircraft (1) also according to the identified visual signals so as to enter or keeping the receiver aircraft (1) in the refueling range or to prevent the contact or command the receiver aircraft (1) disconnection in case of any abnormal situation during the operation arises.

In another embodiment, the opening and closing system of the fuel receiving equipment (3) is additionally configured for opening and closing the fuel receiving equipment (3) based on the identified visual signals.

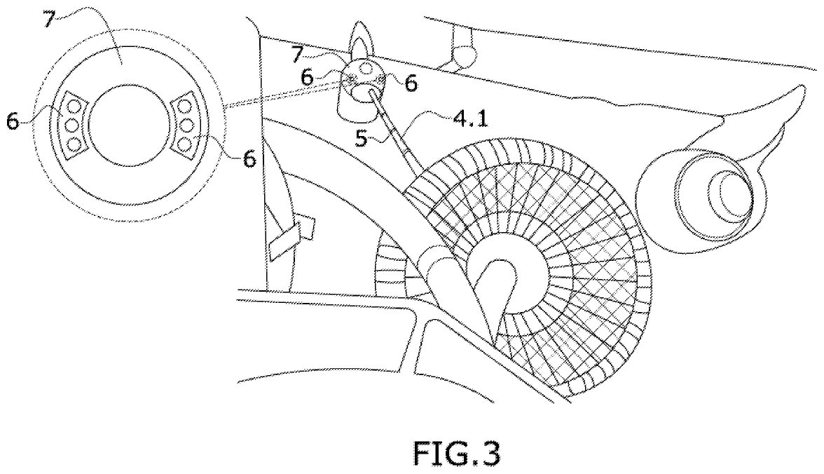

The visual signals may be visual marks (5) located on a deployable part of the fuel dispensing equipment (4), for instance, on the hose (4.1) or on the telescopic boom. This is depicted in FIG. 3.

The hose (4.1) allows the receiver aircraft (1) and the tanker aircraft (2) to readily determine the deployed hose (4.1) length and position within the refueling range. Historically hose (4.1) visual marks (5) every ten feet have been used.

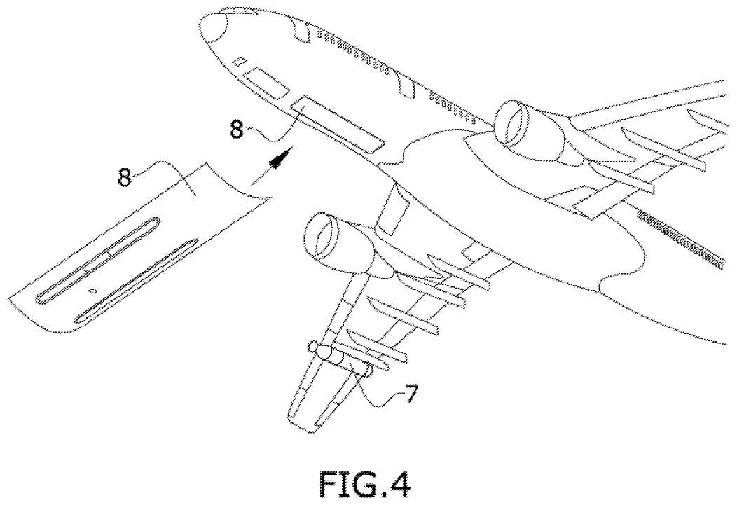

Alternatively, or additionally, the visual signals may be signal lights (6) located in the fuel dispensing equipment (4), for instance, in a pod (7). Another option is Pilot Director Lights (8) located on the belly fairing of the tanker aircraft (2) as shown in FIG. 4.

In an embodiment, the vision system comprises one or more cameras arranged on the receiver aircraft (1). The camera or cameras may be located inside the receiver aircraft (1) cabin or in the front part of the fuselage of the receiver aircraft (1) within a fairing. Cameras are able to operate in day and night conditions.

The image processing system comprises a data base of shapes of tanker aircraft (2), of fuel dispensing equipment (4) and of fuel receiving equipment (3) and compares the captured images with the shapes in the database so as to identify the fuel dispensing equipment (4), the fuel receiving equipment (3) and the tanker aircraft (2).

According to the above, the method for autonomous air-to-air refueling of an aircraft during the different stages of air-to-air refueling operation comprises the following steps:

Capturing images by the vision system arranged on the receiver aircraft (1) of at least a portion of the receiver aircraft (1) comprising the fuel receiving equipment (3) and at least a portion of the surroundings of the receiver aircraft (1) as depicted in FIGS. 1 and 2.

Sending the captured images to a processing system arranged on the receiver aircraft (1).

Processing the received captured images by the image processing system identifying the contour of at least a portion of the tanker aircraft (2), the shape of the fuel receiving equipment (3) and of the fuel dispensing equipment (4) and calculating the relative distance between the fuel dispensing equipment (4) and the fuel receiving equipment (3) and the relative attitude of the tanker aircraft (2) with respect to the receiver aircraft (1).

Varying, based on the distance between the fuel receiving equipment (3) and the fuel dispensing equipment (4) and the relative attitude of the tanker aircraft (2), flight parameters of the receiver aircraft (1) by a receiver aircraft positioning system in communication with the image processing system for approaching and aligning the receiver aircraft (1) with the tanker aircraft (2) so that the fuel dispensing equipment (4) and the fuel receiving equipment (3) make and maintain contact for performing a refueling operation.

In an embodiment, the method further comprises the step of opening and closing the fuel receiving equipment (3) for starting and stopping the refueling by the opening and closing system of the fuel receiving equipment (3) based on the preset relative distance between the fuel receiving equipment (3) and the fuel dispensing equipment (4) and on the relative attitude of the tanker aircraft (2).

In an embodiment, the fuel dispensing equipment (4) comprises visual signals indicating that the receiver aircraft (1) is located in an optimum refueling zone with respect to the tanker aircraft (2) and the method comprises the steps of:

identifying in the captured images the visual signals by the image processing system, and

varying the flight parameters of the receiver aircraft (1) and, optionally, opening and closing the fuel receiving equipment (3), also according to the identified visual signals.

According to the different phases, the method may comprise the following steps:

a precontact phase in which the image processing system identifies the shape of the fuel receiving equipment (3), the fuel dispensing equipment (4) and the contour of at least a portion of the tanker aircraft (2) and calculates the relative distance between the fuel dispensing equipment (4) and the fuel receiving equipment (3) and the relative attitude of the tanker aircraft (2) with respect to the receiver aircraft (1), the receiver aircraft positioning system varies on the basis of the distance between the fuel receiving equipment (3) and the fuel dispensing equipment (4) and the relative attitude of the tanker aircraft (2), flight parameters of the receiver aircraft (1) for approaching and aligning the fuel dispensing equipment (4) and the fuel receiving equipment (3),

a contact phase in which the image processing system identifies the visual signals, the shape of the fuel receiving equipment (3), the fuel dispensing equipment (4) and the contour of at least a portion of the tanker aircraft (2), and the receiver aircraft positioning system varies, based on the distance between the fuel receiving equipment (3) and the fuel dispensing equipment (4), the relative attitude of the tanker aircraft (2), the contour of the tanker aircraft (2) and the identified visual signals, flight parameters of the receiver aircraft (1) for fine or precise approaching and aligning the fuel dispensing equipment (4) and the fuel receiving equipment (3) so as to perform contact,

a fuel transfer phase, the image processing system identifying the visual signals, the tanker aircraft (2) contour, the shape of the dispensing equipment (4) and of the receiving equipment (3) and the receiver aircraft (1) positioning system keeping, based on the identified visual signals, flight parameters of the receiver aircraft (1) for performing fuel transfer and the opening and closing system of the fuel receiving equipment (3) opening the fuel receiving equipment (3) for starting and performing the refueling,

a disengagement phase, the opening and closing system of the fuel receiving equipment (3) comprising a fuel weight measurement system and closing the fuel receiving equipment (3) for stopping refueling from a valid preset fuel weight of the receiver aircraft (1) or based on the visual signals and the receiver aircraft positioning system varying, based on the opening and closing system of the fuel receiving equipment (3) or on the visual signals, flight parameters of the receiver aircraft (1) for disengagement.

In the embodiment shown in the figures, the contact phase control loop will be then allowed by the system based on the tanker drogue (4.2) versus receiver probe (3.1) position and signal lights status (AMBER), drogue stability and critical interface systems health status.

Drogue stability is detected when the position of the drogue is oscillating below a certain range and rate versus certain reference points such as tanker aircraft (2) contour.

Once the contact is confirmed, the system will start controlling the relative position between tanker aircraft (2) versus receiver aircraft (1) to maintain the receiver aircraft (1) within the refueling range based on hose (4.1) marks and GREEN signal light image data.

Also, the availability/integrity of the flight control system would be identified and verified. In addition, if it has any degradation that does not allow the control of the vertical/horizontal position of the aircraft, the availability of the auto thrust mode of the engine power control or also the availability of the fuel system, for example in case of not having the fuel quantity computation available, then the system will not allow the contact to be made or will abort current contact if separation is considered to meet secure conditions.

Once dispense is finished, i.e., fuel target is achieved or any abnormal situation needing to stop the operation arises, necessary commands to close the fuel receipt valves of the fuel system and to the Flight Control and Guidance System to reduce the speed and start disconnection phase will be transmitted. Drogue (4.2) and probe (3.1) are disengaged, and receiver aircraft (1) exit the contact position.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for autonomous air-to-air refueling of an aircraft, the system configured to be arranged on a receiver aircraft configured to be refueled by a tanker aircraft, the receiver aircraft comprising a fuel receiving equipment and the tanker aircraft comprising a fuel dispensing equipment, the fuel receiving equipment being configured to receive fuel from the fuel dispensing equipment, the system for autonomous air-to-air refueling of an aircraft comprising:
a vision system configured to be arranged on the receiver aircraft and configured to capture images of at least a portion of the receiver aircraft comprising the fuel receiving equipment and at least a portion of the tanker aircraft comprising the dispensing equipment,
an image processing system configured to be arranged on the receiver aircraft and configured to receive the images captured by the vision system and configured to process said received images to identify a shape of the fuel receiving equipment, of the fuel dispensing equipment and a contour of at least a portion of the tanker aircraft and configured to calculate a distance between the fuel dispensing equipment and the fuel receiving equipment and a relative attitude of the tanker aircraft with respect to the receiver aircraft,
a receiver aircraft positioning system in communication with the image processing system and configured to vary, based on the distance between the fuel receiving equipment and the fuel dispensing equipment and the relative attitude of the tanker aircraft, flight parameters of the receiver aircraft for approaching and aligning the receiver aircraft with the tanker aircraft so the fuel dispensing equipment and the fuel receiving equipment make contact, maintain contact or disconnect for performing a refueling operation.

2. The system for autonomous air-to-air refueling of an aircraft, according to claim 1, further comprising an opening and closing system of the fuel receiving equipment configured to open and close the fuel receiving equipment to start and stop the refueling based on a preset relative distance between the fuel receiving equipment and the fuel dispensing equipment and on the relative attitude of the tanker aircraft.

3. The system for autonomous air-to-air refueling of an aircraft, according to claim 2, wherein the opening and closing system of the fuel receiving equipment comprises a fuel weight measurement system and is configured to close the fuel receiving equipment to stop refueling from a valid preset fuel weight of the receiver aircraft measured by the fuel weight measurement system.

4. The system for autonomous air-to-air refueling of an aircraft, according to claim 1, wherein the fuel dispensing equipment comprises visual signals configured for indicating when the receiver aircraft is located in an optimum refueling zone with respect to the tanker aircraft, the image processing system being configured to identify in the captured images the visual signals of the fuel dispensing equipment and the receiver aircraft positioning system being configured to vary flight parameters of the receiver aircraft according to the identified visual signals.

5. The system for autonomous air-to-air refueling of an aircraft, according to claim 3, wherein the opening and closing system of the fuel receiving equipment is additionally configured for opening and closing the fuel receiving equipment based on identified visual signals.

6. The system for autonomous air-to-air refueling of an aircraft, according to claim 4, wherein the visual signals are visual marks located on a deployable part of at least one of the fuel dispensing equipment, signal lights located in the fuel dispensing equipment, or Pilot Director Lights located on the tanker aircraft.

7. The system for autonomous air-to-air refueling of an aircraft, according to claim 1, wherein the vision system comprises one or more cameras arranged on the receiver aircraft.

8. The system for autonomous air-to-air refueling of an aircraft, according to claim 7, wherein the camera or cameras are located inside a cabin of the receiver aircraft or within a fairing in a front part of a fuselage of the receiver aircraft.

9. The system for autonomous air-to-air refueling of an aircraft, according to claim 1, wherein the image processing system comprises a database of shapes of the portion of the tanker aircraft, the fuel dispensing equipment and the fuel receiving equipment and is configured to compare the captured images with the shapes in the database to identify the fuel dispensing equipment, the fuel receiving equipment and the tanker aircraft.

10. The system for autonomous air-to-air refueling of an aircraft, according to claim 1, wherein the flight parameters of the receiver aircraft are at least one of height, lateral displacement or engine thrust.

11. The system for autonomous air-to-air refueling of an aircraft, according to claim 1, wherein the relative distance between the fuel dispensing equipment and the fuel receiving equipment is configured to be calculated by a distance in an appropriate coordinate system between a coupling area of the fuel receiving equipment and a coupling area of the fuel dispensing equipment.

12. A receiver aircraft configured to be refueled by a tanker aircraft, the receiver aircraft comprising a fuel receiving equipment and the tanker aircraft comprising a fuel dispensing equipment, the fuel receiving equipment being configured to receive fuel from the fuel dispensing equipment, the receiver aircraft comprising a system for autonomous air-to-air refueling of an aircraft according to claim 1.

13. A method for autonomous air-to-air refueling of a receiver aircraft configured to be refueled by a tanker aircraft, the receiver aircraft comprising a fuel receiving equipment and the tanker aircraft comprising a fuel dispensing equipment, the fuel receiving equipment configured to receive fuel from the fuel dispensing equipment, the being method for autonomous air-to-air refueling of a receiver aircraft comprising the following steps:
capturing images by a vision system arranged on the receiver aircraft of at least a portion of the receiver aircraft comprising the fuel receiving equipment and at least a portion of the tanker aircraft comprising the dispensing equipment,
sending the captured images to an image processing system arranged on the receiver aircraft,
processing the received captured images by the image processing system identifying a shape of the fuel receiving equipment, of the fuel dispensing equipment and of a contour of at least a portion of the tanker aircraft and calculating a distance between the fuel dispensing equipment and the fuel receiving equipment and a relative attitude of the tanker aircraft with respect to the receiver aircraft,
varying, based on the distance between the fuel receiving equipment and the fuel dispensing equipment and the relative attitude of the tanker aircraft, flight parameters of the receiver aircraft by a receiver aircraft positioning system in communication with the image processing system for approaching and aligning the receiver aircraft with the tanker aircraft so that the fuel dispensing equipment and the fuel receiving equipment make contact, maintain contact or disconnect for performing a refueling operation.

14. The method for autonomous air-to-air refueling of an aircraft, according to claim 13, further comprising the step of opening and closing the fuel receiving equipment to start and stop the refueling by an opening and closing system of the fuel receiving equipment based on a preset relative distance between the fuel receiving equipment and the fuel dispensing equipment and on the relative attitude of the tanker aircraft.

15. The method for autonomous air-to-air refueling of a receiver aircraft, according to claim 14, comprising the following phases:
a precontact phase, the image processing system identifying the shape of the fuel receiving equipment, of the fuel dispensing equipment and of the contour of at least a portion of the tanker aircraft and calculating the relative distance between the fuel dispensing equipment and the fuel receiving equipment and the relative attitude of the tanker aircraft with respect to the receiver aircraft, the receiver aircraft positioning system varying based on the distance between the fuel receiving equipment and the fuel dispensing equipment and the relative attitude of the tanker aircraft, flight parameters of the receiver aircraft for approaching and aligning the fuel dispensing equipment and the fuel receiving equipment,
a contact phase, the fuel dispensing equipment comprising visual signals configured for indicating when the receiver aircraft is located in an optimum refueling zone with respect to the tanker aircraft, the image processing system identifying in the captured images the visual signals, the tanker aircraft contour, the shape of the dispensing equipment and of the receiving equipment and the receiver aircraft positioning system varying, based on the distance between the fuel receiving equipment and the fuel dispensing equipment, the relative attitude of the tanker aircraft, the contour of the tanker aircraft and the identified visual signals, flight parameters of the receiver aircraft for fine approaching and aligning the fuel dispensing equipment and the fuel receiving equipment to perform contact,
a fuel transfer phase, the image processing system identifying the visual signals, the tanker aircraft contour, the shape of the dispensing equipment and of the receiving equipment and the receiver aircraft positioning system keeping, based on the identified visual signals, flight parameters of the receiver aircraft for performing fuel transfer and the opening and closing system of the fuel receiving equipment opening the fuel receiving equipment for starting and performing the refueling,
a disengagement phase, the opening and closing system of the fuel receiving equipment comprising a fuel weight measurement system and closing the fuel receiving equipment for stopping refueling from a valid preset fuel weight of the receiver aircraft or based on the visual signals and the receiver aircraft positioning system varying, based on the opening and closing system of the fuel receiving equipment or on the visual signals, flight parameters of the receiver aircraft for disengagement.
